(19) United States
(12) Patent Application Publication
(10) Pub. No.: US 2003/0164894 A1
(43) Pub. Date: Sep. 4, 2003

(54) Optical chassis of plating film reflection and its manufacturing procedure

(76) Inventors: Chuan-Yu Hsu, Hsinchu (TW); Chih-Wen Huang, Hsinchu (TW)

Correspondence Address: Raymond Sun, 12420 Woodhall Way, Tustin, CA, 92782, US

(21) Appl. No.: 09/827,061

(22) Filed: Apr. 5, 2001

(51) Int. Cl. H04N 5/225

(52) U.S. Cl. 348/374

(57) ABSTRACT

An optical chassis of plating film layer reflection and its manufacturing procedure, the optical chassis includes: a shell body, a light source, plural reflection elements, a lens set, and an imaging apparatus. The reflection elements made of glass material in the prior art are changed to a layer or multi-layer of plating films of reflection material which are directly coated on the inside walls of the shell body of an optical chassis and used as the reflection elements thereof. Also, the shell body is designed as a structure for easy off-die and assembly. Not only the present invention completely gets rid of the prior positioning devices for glass mirrors, such as spring pieces, screws, and the like, but also it decreases the number of parts, saves assembly time and lowers the production cost. And, further it is without lowering the quality of image scanning, which is resulted from no loose or no movement of the reflection elements.

### BACKGROUND OF THE INVENTION

1. Field of the Invention

The present invention relates to an optical chassis of plating film reflection and its manufacturing procedure, especially to a kind used in an optical scanner, by which the inside walls of the optical chassis are directly plated with a layer of reflection material used as the reflection mirrors for a kind apparatus of optical chassis, and its corresponding manufacturing procedures.

2. Description of the Prior Art

Please refer to FIG. 1, which is an embodiment of an optical scanner 1 of flat bed of typical type and can be seen in current market. The major feature is a document window glass 12 provided on the upper surface of an outer shell 11 of a scanner 1 to support a document (not shown in the figure) waiting for scanning. An image-scanning job carries out on the document put on the glass 12 by a driving device 13 to activate an optical chassis 14 inside a hollow shell 11 to make a linear motion along a guiding rod 15.

Please refer to FIG. 2, which is an A-A cross-section view of the optical chassis 14 of the prior optical scanner 1 shown in FIG. 1. The optical chassis includes: a hollow shell body 141, a light source 142 positioned on an appropriate position of the upper surface of the shell body 141, plural reflection mirrors 143, a lens set 144, and a charge-coupling device 145. The light source 142 emits light onto the document (not shown in the figure) put on the glass 12. After the reflected light enters into the shell body 141 of the optical chassis 14, the light is reflected several times to increase its optical length to an appropriate length by the plural refection mirrors 142. The light is focused into an image on the charge-coupling device 145 by the lens set 144, and then the scanned image is transferred into electronic signals.

As the prior optical chassis 14 shown in FIG. 1 and FIG. 2, because the sliver plated on the glass pieces constructs the reflection mirrors 143, it is necessary to fix the mirrors on the predetermined positions inside the shell body 141 by spring pieces 146, fixture devices or in accordance with screw fixtures. Not only the additional positioning elements including spring pieces 146, fixture devices and the like will directly cause the increase of the production cost and the number of parts, no further reduction of the size of optical chassis due to shortage of space occupied by too many parts, and the raise of assembly time and labor cost, but also as the number of assembly parts is increased, it will happen the inevitable situation of quality lowering down for scanned images caused by the deviated position of reflection mirrors, which is caused by the parts loose and uneven strength of holding. Furthermore, in prior arts, by applying the spring pieces 146 as the fixture devices for holding the reflection mirrors 143, in long term, it will cause an elasticity fatigue for the spring pieces 146 and weaken the holding strength, or under the situation of vibration caused by the transportation of machine, it may happen the situation of loose or position deviation for reflection mirrors 143 and cause the quality lowering down for scanned images, and they are all waiting for further improvement.

### SUMMARY OF THE INVENTION

The major object of the present invention is to provide an optical chassis of plating film reflection and its manufacturing procedure, which may reduce the number of parts inside the optical chassis, save the time and the cost for assembly and manufacture, and avoid the occurrence of reflection element loose and position deviation.

Another object of the present invention is to provide an optical chassis of plating film reflection and its manufacturing procedure, which have a shell body structure of optical chassis for easy production and assembly and may save the time and the cost for the production and assembly of the shell body of optical chassis.

To achieve the above-mentioned objects, the optical chassis of plating film reflection includes:

a shell body, which has a hollow accommodation space, wherein a pair of opposite inside walls are defined;

plural reflection elements, which is provided inside the accommodation space of the shell body with appropriate, corresponding angles and may make appropriate reflections on the light that enters into the shell;

a lens set, which may focus the light reflected by the reflection elements; and

an imaging apparatus, through which the focused light may be imaged on it and be transferred into image data;

wherein, several inter-corresponding reflection planes, formed on the two corresponding inside walls of the accommodation space of the shell body, provide the installation for the plural reflection elements. The reflection planes are directly formed on the two corresponding inside walls by the method of plastic injection to one body. And, the plating films of reflection materials provided directly on the reflection planes construct the reflection elements.

wherein, the layers of plating film may be silver, chromium, aluminum, platinum and their alloys, which are directly arranged on the reflection planes by one of following methods: evaporating sputtering, sputtering and chemical deposition.

In a preferable embodiment, the plating film further is coated with protection materials, such as PE plastic film or other macromolecular materials with high light transmittance.

In an another more preferable embodiment, the shell body is composed of a lid body and a major body. Further, several corresponding button-up structures, arranged respectively on the connection positions of each major body and lid body, directly buckle and fasten the two bodies together on a fixed position.

More preferably, in the lid body, a supporting platform of light source is arranged to support a light source and a narrow long diaphanous groove is provided for the light to enter into the shell body. Or, in the design of another embodiment, a supporting platform of light source is arranged in the major body and a corresponding narrow long diaphanous groove is provided in the lid body.

Preferably, at least one open hole in assistance for off-die is further arranged on the bottom of the major body.

A preferable embodiment according to the manufacturing procedure of an optical chassis of plating film reflection of the present invention includes the following steps:

(A) shaping the shell body;

(A1) selective surface smoothness treatment aiming on reflection planes of the shell body;

(A2) selectively determining the layer number of plating films according to the requirement of light reflectivity;

(B) plating at least one layer of reflection material on several reflection planes of the shell body to form the plating films; and

(B1) selectively coating protection materials on the plating films to protect the plating films.

To make the esteemed review committee can further understand and recognize the present invention, a detailed description in accordance with several accompanying diagrams are as following:

### BRIEF DESCRIPTION OF THE DRAWINGS

FIG. 1 is a three-dimension illustration for a preferable embodiment of the prior optical scanner.

FIG. 2 is an A-A cross-section-view diagram for an optical chassis of the prior optical scanner in FIG. 1.

FIG. 3 is a cross-section-view diagram for a preferable embodiment of an optical chassis of plating film reflection of the present invention.

FIG. 4 is a flow-path diagram of the manufacturing procedure for an optical chassis of plating film reflection of the present invention.

FIG. 5 is another embodiment of the shell body of an optical chassis of plating film reflection of the present invention.

FIG. 6 is a farther embodiment of the shell body of an optical chassis of plating film reflection of the present invention.

FIG. 7 is an illustration of three-dimensional decomposition for the shell body shown in FIG. 6.

FIG. 8 is a further embodiment of the shell body of an optical chassis of plating film reflection of the present invention.

FIG. 9 is an another farther embodiment of the shell body of an optical chassis of plating film reflection of the present invention.

### DETAILED DESCRIPTION OF THE PREFERRED EMBODIMENT

The major characteristics of the optical chassis of plating film reflection of the present invention are one or more layers of plating film of reflection material, directly plated on the inside walls of the shell body of the optical chassis, and provided as reflection elements, which are in lieu of reflection mirror elements made of glass material in the prior art, and the structure of the shell body of the present invention is designed as an apparatus of easy off-die. Not only the present invention completely gets rid of the prior positioning devices for glass lens, such as spring pieces, fixtures, and screws, etc., but also it decreases the number of parts and saves the assembly labor time and the production cost of the optical chassis. And, further it is without lowering the quality of image scanning, which is resulted from no loose or no movement of the reflection elements.

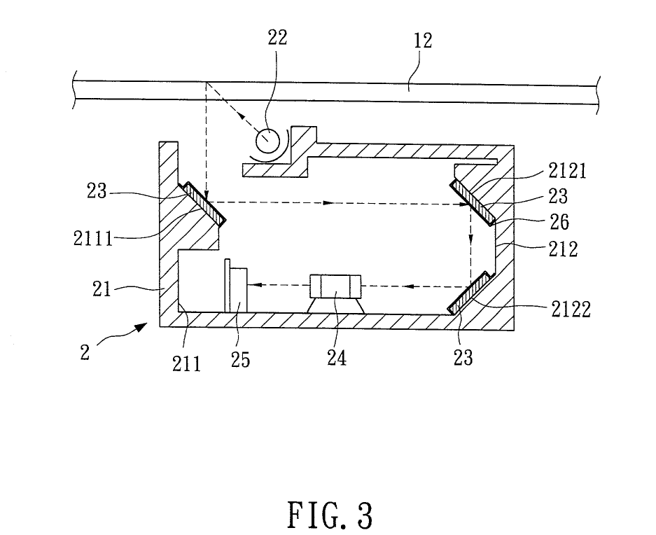

Please refer to FIG. 3, which shows an illustration of the first preferable embodiment of the optical chassis 2 of plating film reflection of the present invention. The optical chassis 2 of plating film reflection includes: a shell body 21, a light source 22, plural plating films 23 constituted as reflection elements, a lens set 24 and an imaging apparatus 25.

The shell body 21, which has a hollow accommodation space, wherein two opposite inside walls 211, 212 are defined. On the two opposite inside walls 211, 212 of the interior accommodation space of the shell body 21, several reflection planes 2111, 2121, 2122 with predetermined angles and corresponding positions are provided and adhered with plural plating films 23. Wherein, the reflection planes 2111, 2121, 2122 are formed directly on two opposite inside walls 211, 212 of the shell body 21 by method of plastic injection to one body, and they may be selectively burnished to increase the surface smoothness.

After the light source 22 installed on appropriate position of the upper side of the shell body 21 provides light emitting onto the document window glass 12, the reflection light enters into the shell body 21 and is appropriately reflected and changed direction by several plating films 23 which are arranged with appropriate angles. The reflected and direction-changed light is focused by the lens set 24 and formed an image on the imaging apparatus 25, by which the scanned image is changed into electronic signals. In this preferable embodiment, the imaging apparatus 25 is a charge-coupling device (CCD), even can be an image pick-up apparatus of CMOS.

More preferable, a protection material 26 can be further coated on the plating film 23 to protect the plating film 23. The protection material 26 may be macromolecular polymer with high light transmittance preferably, such as PE or PV plastic film, etc.

Since the reflection elements of the present invention are constructed by the reflection plane 2111, 2121, 2122, on which the plating films 23 of reflection material are provided directly, so additional positioning devices as provided in the prior arts for assembling the reflection glass mirrors are completely unnecessary. Therefore, not only the structure of the optical chassis of the present invention is more concise, but also reflection elements and corresponding positioning devices can be exempted. Not only the whole structure is lighter and smaller, but also it can save time, labor and cost on assembly and manufacturing procedure. Not only it is unnecessary to worry about the quality lowering down influenced by the loose and movement of prior positioning devices, such as spring pieces, fixtures, and screws, etc., but also it may further reduce the volume of the optical chassis 2 of the present invention by omitting these positioning devices.

In a preferable embodiment, the material of the shell body 21 may be plastic and the shell body may be manufactured by the methods of die-casting or injection. Or, the material may be aluminum and manufactured by the method of squeeze forming. However, the shell body 21 can also be made of other materials. The reflection materials of the plating films 23 may be silver, chromium, aluminum, platinum or other material with good reflection of light. The plating films 23 are formed on the reflection planes 2111, 2121, 2122 by evaporating sputtering, sputtering, chemical deposition or other methods. The thickness of the plating films 23 can be single layer or multi-layer. Traditionally, due to the focusing effect of the lens set 24, so thicker or more layers of the plating films 23 are necessarily plated on the reflection plane 2122 that is closer to the lens set 24. Then, the strength of the reflected light will not be reduced due to the situation of absorption or scattering. Further, since the light reflectivity is raised, so a planer and smoother reflection plane is needed. The thickness of the plating films 23 plated on the reflection plane 2111 located farther to the lens set 24 may be relatively thinner.

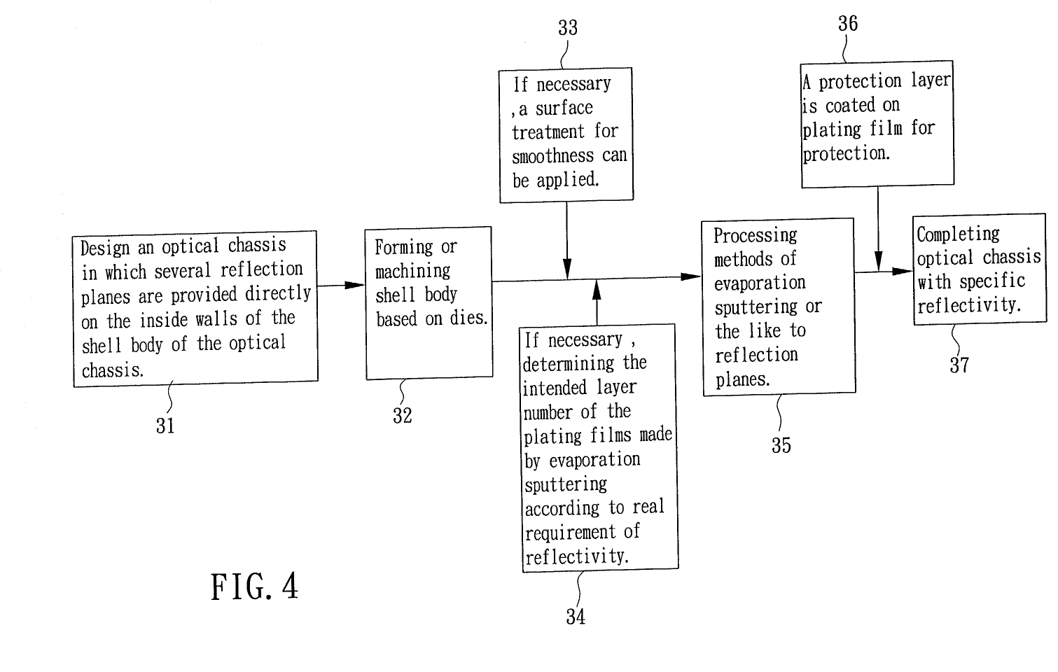

Please refer to FIG. 4, which is a preferable embodiment of the manufacturing procedure of the optical chassis of plating film reflection of the present invention, and the manufacturing procedure includes following steps:

(Step 31) Designing an optical chassis, in which several reflection planes are provided directly on the inside walls of the shell body of the optical chassis by the application of plating process with appropriate and corresponding angles, then corresponding production dies are manufactured according to the design of the optical chassis.

(Step 32) Forming the shell body based on the dies, for example, the shell body is manufactured by the methods of die-casting, or die plastic injection forming, or by other methods (for example, milling machine or CNC working machine).

(Step 33) If necessary, for example, when an optical scanner with higher resolution needs a more even reflection surface, a surface treatment for smoothness can be applied on the reflection surfaces of the shell body, such as the processes of polish or grinding.

(Step 34) If necessary, determining the intended layer number of the plating films made by evaporation sputtering according to the real requirement of the reflectivity.

(Step 35) Forming the plating films of predetermined layer number on the reflection planes by the processing methods of evaporation sputtering, sputtering, chemical deposition, or the like.

(Step 36) If necessary, a protection layer of protection materials is further coated on the plating film to protect the plating film from damaging or hurting. The protection materials are macromolecular polymers, such as PE or PV film, etc.

(Step 37) Completing the optical chassis with specific reflectivity.

In another embodiments described thereinafter, since most elements are identical or similar to the above-mentioned embodiments, so same names and reference numbers are assigned to the identical or similar elements without repetitious description and only another character is appended to the original number for the purpose of distinguishing.

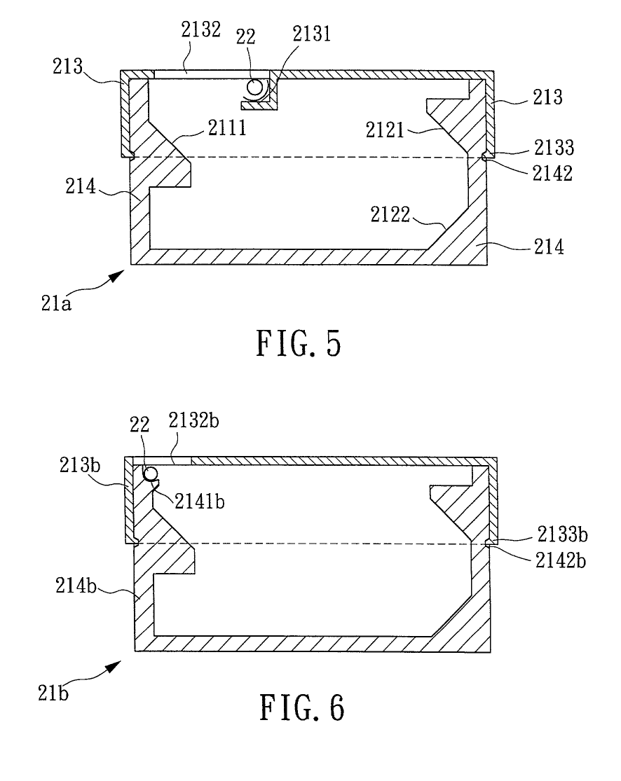

Please refer to FIG. 5, in which is another preferable embodiment of the shell body 21a of the optical chassis of the plating film reflection of the present invention. For the convenience of off-die during the practical manufacture of the shell body 21a, in this embodiment, the shell body 21a is separated to two parts, i.e. a lid body 213 and a major body 214. And, each part is manufactured separately, then assembling the manufactured two parts together to constitute the shell body 21a. Wherein, a light source supporting platform 2131 is further installed on the shell body 213 to support the light source 22 and a long narrow diaphanous groove 2132 provided for light that enters into the shell body 21. Several button-up devices 2133, 2142 are correspondingly arranged on the corresponding interconnection positions of the major body 214 and the lid body 213 (such as the coordination of tenons and mortises). So, the major body 214 and the lid body 213 are directly fastened and connected together to a fixed position by the button-up devices 2133, 2142.

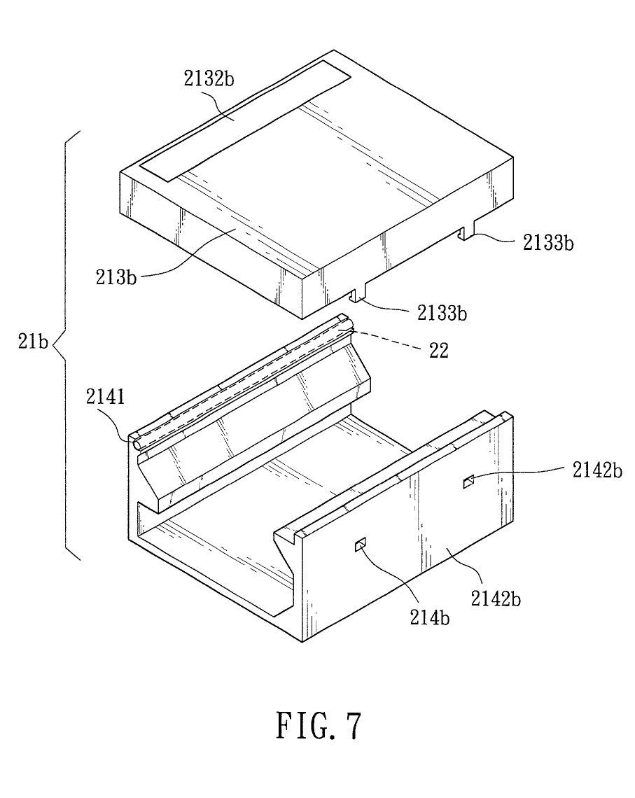

Please refer to FIG. 6 and FIG. 7, in another further preferable embodiment of the shell body 21b of the optical chassis of the plating film reflection of the present invention, similarly, the shell body 21b is constituted of two parts, i.e. the lid body 213b and the major body 214b. Several corresponding button-up devices of tenon 2133b and mortise 2142b are similarly arranged on corresponding interconnection positions of the major body 214b and the lid body 213b. The difference is, in this embodiment, a light source supporting platform 2141b is arranged on the major body 214b to support the light source 22, and a narrow long diaphanous groove 2132b is arranged on the lid body 213b corresponding to the position of the light source supporting platform 2141b for the provision of light which enters into the shell body 21b. Preferably, the major body 214 can be manufactured by the methods of aluminum squeeze forming or cold squeeze and its material can be any kind of metal. And, the lid body 213 can be manufactured by the methods of plastic injection or die-casting and it can be of the materials of metal or plastic.

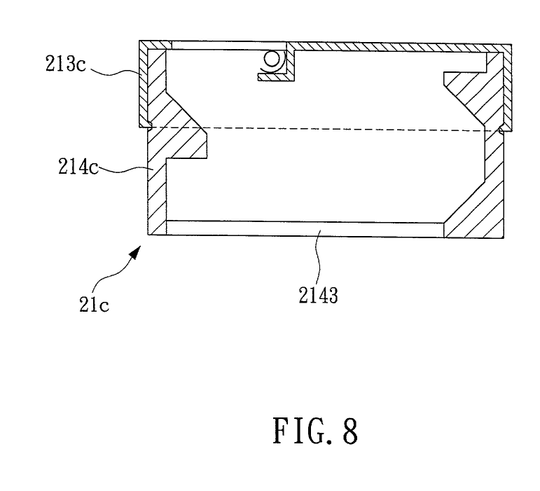

Please refer to FIG. 8, in another further preferable embodiment of the shell body 21c of the optical chassis of the plating film reflection of the present invention, similarly, the shell body 21c is constituted of two parts, i.e. the lid body 213c and the major body 214c. The difference is, in this embodiment, at least one open hole 2143 in assistance for off-die is further arranged on the bottom of the major body 214c to make the shell body be designed and manufactured in more easy way, in the mean time, it can reduce the weight of the optical chassis.

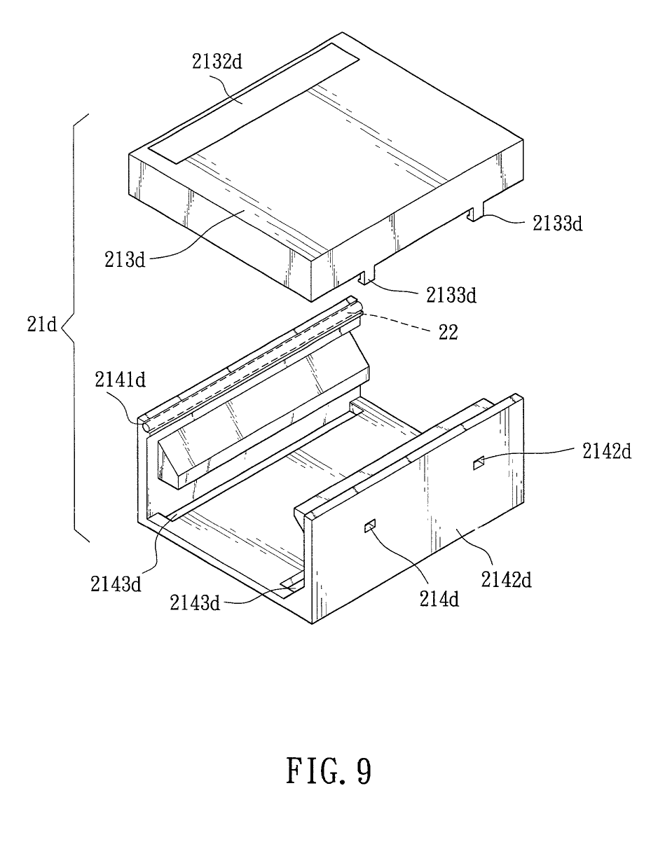

Please refer to FIG. 9, which is also another further preferable embodiment of the shell body 21d of the optical chassis of the plating film reflection of the present invention. The embodiment shown in FIG. 9 is roughly same as that in FIG. 7. Similarly, the shell body 21d is constituted of two parts, namely, the lid body 213d and the major body 214d. Several corresponding button-up devices of tenon 2133d and mortise 2142d are similarly arranged on corresponding interconnection positions of the major body 214d and the lid body 213d. Similarly, a light source supporting platform 2141d is arranged on the major body 214d to support the light source 22, and a narrow long diaphanous groove 2132d is arranged on the lid body 213d corresponding to the position of the light source supporting platform 2141d for the provision of light that enters into the shell body 21d. The difference is, in this embodiment, several open holes 2143d, in assistance for off-die is further arranged on the bottom of the major body 214d, are corresponding to the position of protruding reflection plane to make the shell body 21d be designed and manufactured more easily by the methods of plastic injection and die-casting, in the mean time, it can reduce the weight of the optical chassis.

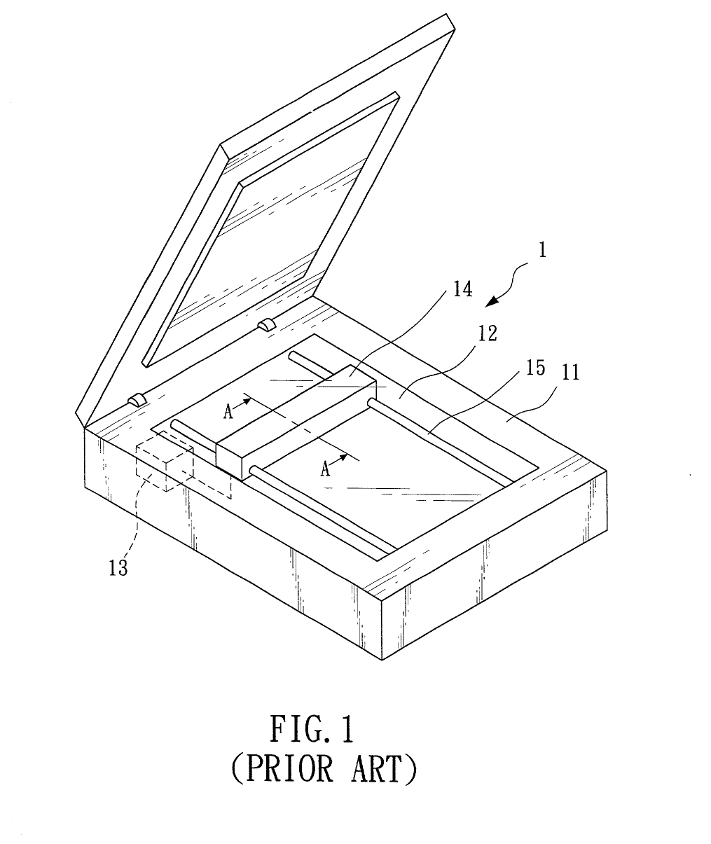

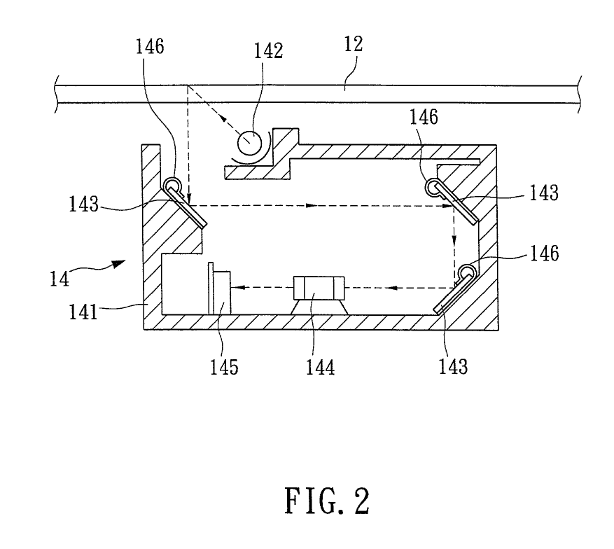

In summary, corresponding to the prior arts shown in FIG. 1 and FIG. 2, the optical chassis of plating film reflection of the present invention at least has following advantages:

(1) The production cost is lower. Not only the plating films of reflection material directly provided on the shell body of the optical chassis has further lower production cost than that of glass reflection mirrors, but also the cost of manufacture and assembly is saved from the traditional positioning devices, such as fixtures and spring pieces, etc.

(2) Easy assembly and reducing labor time. Not only the plating films directly formed on the reflection planes of the shell body can save labor and cost, but also it won't worry the quality of scanned image will be lowered down caused by the loose or movement of the prior positioning devices, such as spring pieces, fixtures and screws, etc. And, further, because the positioning devices are omitted, the volume of the optical chassis of the present invention can be contracted.

(3) More preferable flexibility of application is available by controlling the reflectivity corresponding to the layer number of the plating films.

(4) The shell body can be decomposed into two parts, i.e. the lid body and the major body, which can be manufactured separately and then connected together directly by the fastening structures. No any locking element is completely needed. Furthermore, the shell body of the present invention is further easy to off-die and produce. And, the plating films can be made more easily onto the reflection planes by the method of evaporation sputtering.

The above-mentioned preferable embodiments are applied to describe the present invention in detail, however, they are not the limited scope of the present invention. For example, although the above-mentioned preferable embodiments of the present invention take the optical chassis of the optical scanners as embodiments, but they are also suitable for an optical chassis of a copy machine. Furthermore, although the present invention is explained by an example of an optical chassis with three pieces of reflection mirror, but it also suitable for the optical chassis with two or four pieces of reflection mirror. Therefore, it is apparent to all the persons who well-know such technologies that appropriate and small variation and adjustment still possess the merit of the present invention and is also still within the spirit and the scope of the present invention.

What is claimed is:

1. An optical chassis of plating film reflection comprises:
a shell body, which has a hollow accommodation space, wherein a pair of opposite inside walls are defined;
plural reflection elements, which is provided inside the accommodation space of the shell body with appropriate, corresponding angles and may make appropriate reflections on the light that enters into the shell;
a lens set, which may focus the light reflected by the reflection elements; and
an imaging apparatus, through which the focused light may be imaged on it and be transferred into image data;
the characteristics are:
several inter-corresponding reflection planes, formed on the two corresponding inside walls of the accommodation space of the shell body, provide the installation for the plural reflection elements. And, the plating films of reflection materials provided directly on the reflection planes construct the reflection elements.

2. An optical chassis of plating film reflection according to claim 1, wherein a light source provided on an appropriate position of an upper side of said shell body is further included.

3. An optical chassis of plating film reflection according to claim 1, wherein said imaging apparatus is a charge-coupling device (CCD).

4. An optical chassis of plating film reflection according to claim 1, wherein said reflection planes are directly formed on two inside walls of said shell body by a method of plastic injection forming to one body.

5. An optical chassis of plating film reflection according to claim 1, wherein said reflection planes have been processed with surface polishing.

6. An optical chassis of plating film reflection according to claim 1, wherein said plating films are further coated with protection materials.

7. An optical chassis of plating film reflection according to claim 6, wherein said protection material is macromolecular polymer with high light transmittance.

8. An optical chassis of plating film reflection according to claim 1, wherein said materials of said plating films may be one kind of the following materials: silver, chromium, aluminum, platinum and their alloys.

9. An optical chassis of plating film reflection according to claim 1, wherein said plating films are directly arranged on said reflection planes by one of following methods: evaporating sputtering, sputtering and chemical deposition.

10. An optical chassis of plating film reflection according to claim 1, wherein said shell body comprises a lid body and a major body.

11. An optical chassis of plating film reflection according to claim 10, wherein said lid body is provided with a light source supporting platform and a narrow long diaphanous groove for the provision of light which enters into said shell body.

12. An optical chassis of plating film reflection according to claim 10, wherein a light source supporting platform is further arranged on said major body to support a light source, and a narrow long diaphanous groove is arranged on said lid body corresponding to the position of the light source supporting platform for the provision of light which enters into said shell body.

13. An optical chassis of plating film reflection according to claim 10, wherein at least one open hole in assistance for off-die is further arranged on the bottom of said major body.

14. An optical chassis of plating film reflection according to claim 10, wherein several corresponding button-up structures, arranged respectively on the connection positions of each major body and lid body, directly buckle and fasten said two bodies together on a fixed position.

15. An optical chassis of plating film reflection includes:
a shell body, which has a hollow accommodation space, wherein two opposite inside walls are defined and several inter-corresponding reflection planes are formed on two opposite inside walls with predetermined angles and positions; and
plural plating films, which are constructed by directly arranging reflection materials on several reflection planes and make appropriate reflections and direction changes on the light that enters into the shell body.

16. A manufacturing procedure for manufacturing said optical chassis of plating film reflection according to claim 15 includes following steps:
(A) shaping said shell body; and
(B) plating at least one layer of reflection material on several reflection planes of said shell body to form said plating films.

17. A manufacturing procedure of said optical chassis of plating film reflection according to claim 16, wherein a step is further included after step (A):
(A1) surface smoothness treatment aiming on said reflection planes of said shell body.

18. A manufacturing procedure of said optical chassis of plating film reflection according to claim 16, wherein said surface smoothness treatment is burnishing process.

19. A manufacturing procedure of said optical chassis of plating film reflection according to claim 16, wherein a step is further included after step (A):
(A2) determining the layer number of plating films according to the requirement of light reflectivity.

20. A manufacturing procedure of said optical chassis of plating film reflection according to claim 16, wherein said materials of said plating films may be one kind of the following materials: silver, chromium, aluminum, platinum and their alloys.

21. A manufacturing procedure of said optical chassis of plating film reflection according to claim 16, wherein said plating films are directly arranged on said reflection planes by one of following methods: evaporating sputtering, sputtering and chemical deposition.

22. A manufacturing procedure of said optical chassis of plating film reflection according to claim 16, wherein a step is further included after step (B):
(B1) coating protection materials on said plating films to protect said plating films.

23. A manufacturing procedure of said optical chassis of plating film reflection according to claim 22, wherein said protection material is macromolecular polymer with high light transmittance.

24. A manufacturing procedure of said optical chassis of plating film reflection according to claim 16, wherein said reflection planes are directly formed on two inside walls of said shell body by a method of plastic injection forming to one body.

25. A manufacturing procedure of said optical chassis of plating film reflection according to claim 16, wherein said shell body comprises a lid body and a major body.

26. A manufacturing procedure of said optical chassis of plating film reflection according to claim 25, wherein said lid body is provided with a light source supporting platform and a narrow long diaphanous groove for the provision of light which enters into said shell body.

27. A manufacturing procedure of said optical chassis of plating film reflection according to claim 25, a light source supporting platform is further arranged on said major body to support a light source, and a narrow long diaphanous groove is arranged on said lid body corresponding to the position of the light source supporting platform for the provision of light which enters into said shell body.

28. A manufacturing procedure of said optical chassis of plating film reflection according to claim 25, wherein at least one open hole in assistance for off-die is further arranged on the bottom of said major body.

29. A manufacturing procedure of said optical chassis of plating film reflection according to claim 25, wherein several corresponding button-up structures, arranged respectively on the connection positions of each major body and lid body, directly buckle and fasten said two bodies together on a fixed position.
